(19) United States
(12) Patent Application Publication
(10) Pub. No.: US 2026/0168315 A1
(43) Pub. Date: Jun. 18, 2026

(54) Door Panel with Reinforced Structure and Quick Interchangeability

(71) Applicant: Meiqi Zong, Shanghai (CN)

(72) Inventor: Meiqi Zong, Shanghai (CN)

(21) Appl. No.: 18/984,926

(22) Filed: Dec. 17, 2024

(51) Int. Cl. E06B 3/70

(52) U.S. Cl. CPC E06B 3/70; E06B 2003/7011; E06B 2003/7051; E06B 2003/7063; E06B 2003/7084

(57) ABSTRACT

The invention of the present subject matter relates to a door panel with a reinforced structure, quick interchangeability, and thermal insulation and sound-proofing functions, comprising an insulating core and a pair of panels which are structurally compatible with the insulating core and can be adhered to the insulating core by means of a silicone adhesive. The insulating core is contained within a limiting frame composed of a fiberglass-reinforced polyurethane composite and having a plurality of reinforcing bars. The door panel with the reinforced structure enables the panels to be removed and interchanged with other panels quickly and efficiently.

### FIELD OF INVENTION

The present invention relates to the field of construction, particularly to door panels having reinforced structure, quicky interchangeability, thermal insulation, and sound proofing functionality.

### BACKGROUND OF THE INVENTION

Most conventional door panels are integral, either treated with paint on wooden doors or coated with veneer to achieve various styles. During door frame installation, the paint needs to be applied first, followed by hinge installation, to secure the door panel to the door frame and allow smooth movement. However, problems do persist in the actual installation including limited flexibility in changing door panel styles post-installation. Additionally, due to the fragile structure of the door panel, even with some protection, it is prone to damage such as bumps and scratches. Consequently, repairing a damaged door panel can become challenging, requiring professional personnel for the repair, resulting in high economic and time costs. Given the current situation, a more feasible solution is needed to address these existing technical issues.

### PRIOR ART

There are numerous examples of door panels having some type of insulating core in the prior art. For example, U.S. Pat. No. 4,091,142 to Elmore et al. relates to a structural panel provided for sheets to be placed over structures, such as doors, and having a foam insulating score disposed therebetween. In U.S. Pat. No. 4,282,687 to Teleskivi, a fire-resistant door is disclosed, composed of paneling with an insulating core placed between outside door panels, inducing a central web arrangement. U.S. Pat. No. 10,151,137 to Glover discloses an insulating fiber-reinforced door panels and methods of making therein, including a plurality of different stiffness and shell exteriors and a hardenable material that has an insulating function filling the space between the exterior panels. U.S. Patent Application Publication 2004/0003559 A1 to discloses a rigid foam insulation core disposed between a planar construction door shell. In U.S. Pat. No. 4,282,687 to Minke et al, a fire-resistant door is provided composed of paneling with an insulating core placed between outside door panels, inducing a central web arrangement. U.S. Patent Application Publication 2009/2344038A1 to Coppersmith is directed to thermal and sound building insulation panels having an insulated structure with an internal volume having pressure differences to allow for sound dampening. And, U.S. Patent Application Publication 2023/0392435A1 to Ghauforian provides an interchangeable door panel system comprising interchangeable panels with a mechanism to insert them into the door, the door panels also having an insulating material.

### SUMMARY OF THE INVENTION

The invention of the present subject matter relates to a door panel having a reinforced structure, quick interchangeability, and thermal insulation and soundproofing functions to address and solve the technical problems regarding fixed panel structure, inability to change panel styles, and repair difficulties of door panels after damage.

Accordingly, it is an object of the present subject matter to provide a door panel having a reinforced structure that offers quick interchangeability to change the door panel style post installation.

It is another object of the present subject matter to provide a door panel having a reinforced structure that can be repaired quickly and efficiently.

It is still another object of the present subject matter to provide a door panel having a reinforced structure that provides thermal insulation.

It is a yet another object of the present subject matter to provide a door panel having a reinforced structure which provides enhanced sound-proofing.

It is a further object of the present subject matter to provide a door panel having a reinforced structure which can be finished with different colors, patterns, and styles.

It is yet a further object of the present subject matter to provide a door panel having a reinforced structure comprising a pair of panels which are adhered to an insulating core.

It is still a further object of the present subject matter to provide a door panel having a reinforced structure wherein the pair of panels can have different styles to better integrate into different design aesthetics, thereby achieving a cohesive or personalized appearance.

These and other objects of the present subject matter are accomplished by providing a door panel having a reinforced structure comprising an insulating core and a pair of panels adhered to opposite sides of the insulating core.

### BRIEF DESCRIPTION OF DRAWINGS

FIG. 1 is a schematic diagram of the door panel having a reinforced structure of the present subject matter.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

It is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The present subject matter is directed a door panel having a reinforced structure with quick interchangeability, and is provided with both thermal insulation and soundproofing capabilities. The door panel comprises an insulating core and a pair of panels including a first panel having a first panel edge and a second panel having a second panel edge. Each of the first panel and the second panel are constructed to be structurally compatible with the insulating core and are disposed on either side of the insulating core. Each of the pair of panels are adhered to the insulating core, such as by means of a silicone adhesive. The door panel is removably connected to a door frame.

The insulating core comprises a limiting frame composed of a fiberglass-reinforced polyurethane composite material formed as an outer frame structure of the door, such that the insulating core is housed within the limiting frame and each of the first panel edge and second panel edge of the pair of panels are abutted against the limiting frame. The limiting frame further comprises a plurality of inner holes, having reinforcing bars inserted therethrough. One side of the limiting frame is configured with an avoidance port on the side of the insulating core facing a door frame, wherein a portion of the structure of the limiting frame is embedded in the avoidance port and connected to the insulating core and the pair of panels.

In one embodiment, a door frame is equipped with an anti-collision strip such that the limiting frame forms a hollow structure on one side facing the anti-collision strip. This configuration allows for the placement of a fire prevention strip within the hollow structure when the door panel is to be used as a fire door. The limiting frame is composed of a fiber-glass reinforced polyurethane composite material having good wear resistance, impact resistance, as well as very high tensile and bending strength. Thus, when the limiting frame is in contact with an anti-collision strip on the door frame, its structure remains stable and sealed.

In another embodiment, the insulating core is housed within the limiting frame further comprising a solid wood frame, a medium density fiberboard, and an extruded insulation material. This design configuration allows the door panel to maintain sufficient strength while being lightweight, thereby achieving enhanced fatigue load capabilities.

The solid wood frame is composed of wood, such as pine wood, specifically New Zealand pine. New Zealand pine is characterized by high density and high hardness, has good wear resistance, shock resistance, and durability. These characteristics result in making the door panel of the present subject matter more robust and durable, and having an extended service life. However, as will be obvious to those skilled in the art, the solid wood frame can be composed of any other suitable wood material, including, for example, laminated veneer lumber (LVL). LVL is a commonly used wood processing method that involves stacking and bonding wood veneers along the grain direction to improve strength, stiffness, and stability of the wood.

The reinforcing bars also may be composed of pine wood, particularly New Zealand pine, although and suitable wood material such as laminated veneer lumber (LVL) may be used in the door panel of the present subject matter. In addition of LVL, a variety of other woods are suitable for use as materials for the reinforcing bars, including spliced structures and cross-laminated structures. Specific characteristics or features of suitable woods for fabricating the reinforcing bars include grain pattern, density, and moisture content. For instance, woods exhibiting distinct grain patterns, higher density and lower moisture content are preferred. Specific examples of such woods are pine, oak, and walnut. In addition to wood, the reinforcing bars may be fabricated from other materials including metal, fiberglass, and the like. These materials can be composites with wood to improve strength and stability.

The strength and bending resistance of the door panel of the present subject matter can be enhanced, thereby improving its performance and its service life. As a result, the door panel of the present subject matter improves upon the current simple and fragile door panel structure that fails to ensure good protection. In addition, since the pair of panels are connected to the insulating core by means of silicone adhesive bonding, it is convenient to change the style of the panels to suit different needs, thereby providing more options for different door designs. Further, in the event of damage to the door panel, disassembly and maintenance can be executed easily, thereby lowering the repair difficulty and cost.

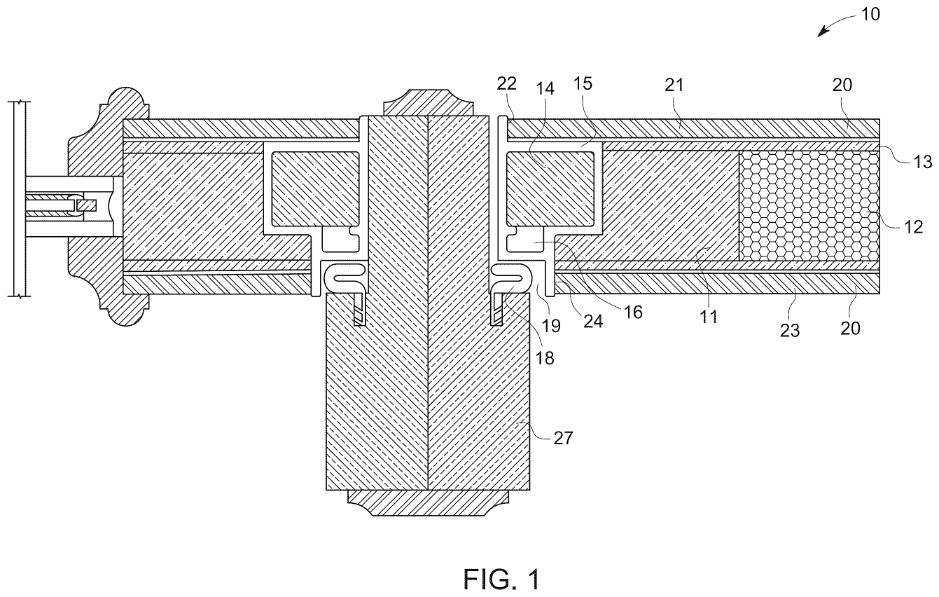

Referring now to FIG. 1, the door panel 10 of the present subject matter comprises an insulating core 12 disposed between a pair of panels 20, a first panel 21 having a first panel edge 22 and a second panel 23 having a second panel edge 24. The insulating core comprises a limiting frame 15 formed as the outer frame structure such that each of first panel edge 22 and second panel edge 24 abut against the limiting frame. The limiting frame further comprises a plurality of inner holes having reinforcing bars 14 inserted therethrough. An avoidance port 19 is disposed on the side of the limiting frame facing door frame 27 such that a portion of the structure of the limiting frame is embedded in the avoidance port and connected to the insulating core and the pair of panels 20. In a preferred embodiment, the limiting frame further comprises a solid wood frame 11, an extruded sheet of insulation core material 12 and a medium density fiberboard 13.

The door frame 27 may be provided with an anti-collision strip 28 configured in such a manner that the limiting frame forms a hollow structure on one side facing the anti-collision strip.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . .”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A door panel having a reinforced structure which is removably attached to a door frame, comprising an insulating core and a pair of panels disposed on either side of said insulating core, said panels including a first panel having a first edge and a second panel having a second edge, each of said first panel and said second panel being configured to be structurally compatible with said insulating core, wherein said insulating core is in the form of a limiting frame comprising:
a. a fiberglass-reinforced polyurethane composite material formed as an outer frame structure of said door panel such that said insulating core is housed within said limiting frame and said first edge of said first panel and said second edge of said second panel each is abutted respectively against said limiting frame;
b. a plurality of inner holes, each inner hole having a reinforcing bar inserted therethrough;
c. a solid wood frame;
d. a medium density fiberboard;
e. an extruded sheet insulation material, and
f. an avoidance port, said avoidance port being configured on the side of the insulating core facing said door frame such that a portion of the structure of said limiting frame is embedded in said avoidance port and connected to said insulating core and said pair of panels.

2. The door panel having a reinforced structure in accordance with claim 1, wherein said door frame is provided with an anti-collision strip and wherein the side of said limiting frame facing the anti-collision strip is formed with a hollow structure which can be adapted to receive a fire prevention strip.

3. The door panel having a reinforced structure in accordance with claim 1, wherein said insulating core is disposed within said limiting frame and the middle are of said solid wood frame contains said extruded sheet of insulation material.

4. The door panel having a reinforced structure in accordance with claim 1, wherein said solid wood frame is composed of pine wood.

5. The door panel having a reinforced structure in accordance with claim 1, wherein said limited frame is composed of a fiberglass-reinforced polyurethane composite containing pine wood.

6. The door panel having a reinforced structure in accordance with claim 1, wherein said reinforcing bars are composed of pine wood.
